(19) United States
(12) Patent Application Publication
(10) Pub. No.: US 2007/0041780 A1
(43) Pub. Date: Feb. 22, 2007

(54) Snap-together pen

(75) Inventor: Ming-Tay Hsu, Chung-Li (TW)

Correspondence Address: Ming-Tay Hsu;Foluck International Co., Ltd, P.O. Box 166-13, Taipei, 115, TW

(73) Assignee: Foluck International Co., Ltd

(21) Appl. No.: 11/207,753

(22) Filed: Aug. 22, 2005

(51) Int. Cl. B43K 29/00

(52) U.S. Cl. 401/195

(57) ABSTRACT

The present invention is aimed to provide a detachably snap-together pen, the figurine coupled to the pen is composed of a plurality of components, the components can be snapped together in different orientations. This pen comprises a hollow, open end barrel 10, a figurine 20 coupled to the barrel and a cartridge 30 mounted inside the barrel. A figurine 20 is composed of at least one of components, each of the components has relative bumps 21 and recesses 22, snapping together the components through the joints of bumps 21 and recesses 22 to form a figurine to couple to a barrel; thus an entertaining assemblage effect is achieved.

### FIELD OF THE PRESENT INVENTION

The present invention is related to a pen can be taken apart and re-assembled repeatedly particularly to a plurality of components assembled to form a pen in pleasurable patterns with educate entertaining effects.

### BACKGROUND OF THE PRESENT INVENTION

There are kinds of lovely pens on the market, one of them is disclosed in the Taiwan Patent No.: M248625 entitled “variable patterned figurine adapted to a pen” assigned to Cheng, Dido on 11 Sep. 2003 comprising: a barrel has a figurine at top end, the head of the figurine is adorned with several pliable bodies, said pliable body is a deformable steel wire wrapped by an elastomer.

The problems of the pens of prior arts usually have not to disassemble into different tiny parts. Even if a pen were taken apart, the tiny parts, for example, such as refill, cap, or barrel, could not be re-assembled like a “logo type play surface”. A lone refill is not expected to write. A barrel, a cap are also deserted parts, though they could not be combined with the refill to form a pen. As a result, pen for writing or drawing has no further heuristic, or educate entertaining effects for children to develop their capability to be creative, imaginative. Meanwhile, pens of prior arts might not be designed for a purpose of illuminating—while writing, the pen is illuminated, otherwise, the pen is not illuminated—thus, pens of the prior arts are not attractive to the young children.

### SUMMARY OF THE INVENTION

Accordingly, one aspect of the present invention is to provide a detachably snap-together pen comprising: a hollow, open end barrel 10, a figurine 20 coupled to a barrel and a cartridge 30 disposed in the barrel characterized in that a figurine 20 is composed of at least one component, each of the components has the corresponding bumps 21 and recesses 22, snaps together the components through the joint of bumps 21 and recesses 22 to form a figurine coupled to a barrel;

Said components are snapped together through the joint of bumps 21 and recesses 22 in the orientation as one of the following: front and rear, right and left, up and down, or in oblique symmetry;

A cartridge 30 is received in the barrel 10 and then an open top end of the barrel 10 is covered with a cap 40;

A bottom component of the figurine 20 is a detachable component formed with the barrel 10 as a whole by injection molding;

A bottom component of the figurine 20 is a detachable component coupled to the top end of barrel 10 by bumps and recesses coupling;

An illuminating device 50 secured to the top end of the cartridge 30, the cartridge 30 is received in the open-end barrel 10;

Said illuminating device 50 lights up or not is switched by a finger-touch triggering switch;

Said illuminating device 50 lights up or not is switched by a press-button triggering switch;

Said illuminating device 50 lights up or not is switched by a cartridge 30, the illuminating device 50 comprises a base 51, an LED 52 mounted in an upper trough 511 of the base 51, the LED 52 has two leads, a short lead is led into a lower trough 512, a long lead 522 is led into the vertical trough 513 then goes across the base 51; two or three batteries 53 mounted in the lower trough 512 of the base 51, the anode of the battery is in contact with a short lead 521 of the LED 52, a compressing spiral spring 54 is provided to fit over the circumference of base 51, an upper end of the compressing spiral spring 54 is in contact with the long lead 522 of the LED 52; a conductive cap 55 is in contact with a lower end of the compressing spiral spring 54 and keeps a gap from the batteries 53 in the base 51, the conductive cap 55 resists the cartridge 30.

In practice, the present invention can be practiced to achieve the advantages as following:

1. The detachably snap together pen is attractive to young children to write or draw with pleasure; especially the figurine 20 of the pen 100 can be taken apart into detachable components but the pen still can be in use. Young children can repeatedly enjoy the pleasure of detachably snap together the figurine and coupled them to the barrel of pen. In which, young children are accustomed to the variable changes of a writing instrument.

2. The components of the pen are not limited to arrange in only one orientation. It is snapped together in the orientation of front and rear, right and left, up and down, or in oblique symmetry. Somewhat a few difficult obstacles challenge children pay more attention, efforts to complete the assembled work. It is heuristic for developing the children's creative, imaginative capabilities.

3. The cartridge 30 in the barrel 10 sealed by a cap 40 in the top end—an open end of the barrel 10, the writing instrument provides the cartridge hidden in the barrel with no damage.

4. Base component of the figurine 20 is a detachable component formed with the barrel 10 as a whole by injection molding; the figurine 20 can be coupled to the barrel 10 based on said base component.

5. Base component of the figurine 20 can be coupled to the top end of barrel 10 in bumps and recesses coupling manner. Figurine 20 can be combined to the barrel 10 or detached from the barrel 10 completely.

6. An illuminating device 50 is added to the top end of the cartridge 30 mounted inside the barrel 10. While illuminating, light rays pass through the figurine with refraction to produce shinning, interesting effects.

7. By means of a finger-touch triggering switch mounted on the barrel 10, the illuminating device 50 is manipulated by hand to emit light or not.

8. By means of a press-button triggering switch mounted on the barrel 10, the illuminating device is manipulated by hand to emit light or not.

9. By means of a cartridge 30 applied to write or not, the LED 52 can be actuated to light or dim automatically, even illuminate the emitting light device 50 without a switch to turn on/off. Actuating the emitting light device by writing automatically is rather more convenient than manipulated by hand.

### BRIEF DESCRIPTION OF THE DRAWINGS

FIG. 1 is an exploded perspective view of the first embodiment of the present invention;

FIG. 2 is a partial exploded perspective view of the first embodiment of the present invention;

FIG. 3 is a partial exploded perspective view of the first embodiment of the present invention;

FIG. 4 is an assembled view of the first embodiment of the present invention;

FIG. 5 is a schematic view of the first embodiment of the present invention in practice;

FIG. 6 is a plan view after assembly of the second embodiment of the present invention;

FIG. 7 is a schematic view of the emitting light device of the second embodiment of the present invention before the device lights up; and

FIG. 8 is a schematic view of the emitting light device of the second embodiment of the present invention when the device lights up.

### DETAILED DESCRIPTION OF THE EMBODIMENTS

The description is described according to the appended drawings hereinafter.

### First Embodiment

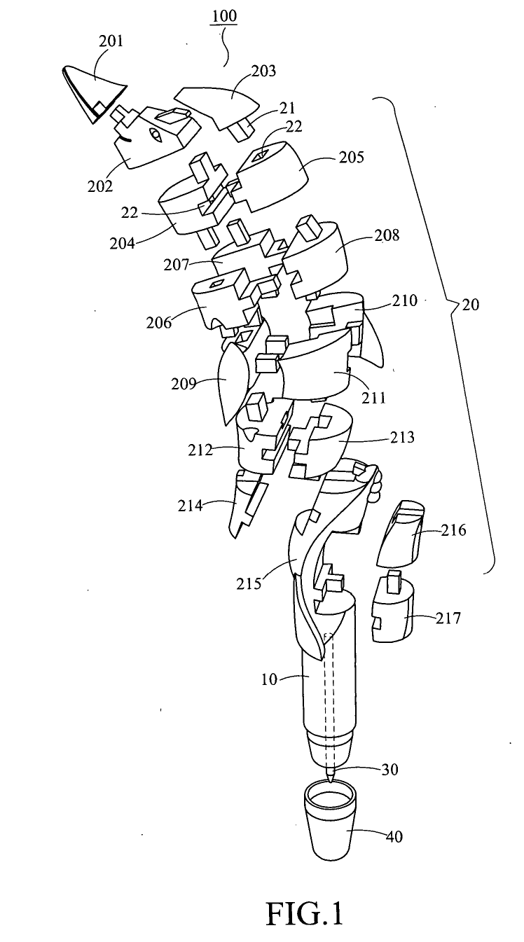

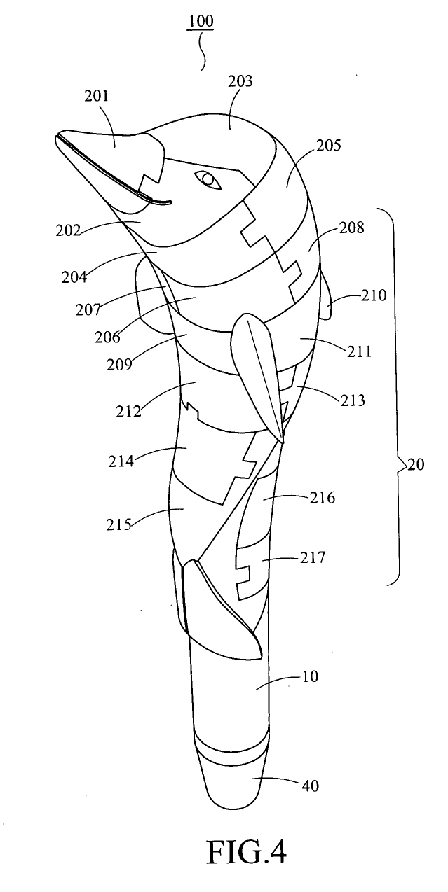

Refer to FIG. 1. An exploded perspective view of the present invention is illustrated. In FIG. 1, an assembled pen 100 (exemplary embodiment of a dolphin figurine) comprises a barrel 10, a figurine 20 coupled to the barrel 10, a cartridge 30 mounted inside the barrel 10, and a cap 40 used for covering the cartridge 30 put in the barrel 10. After assembly, the assembled view of pen 100 is illustrated in FIG. 4.

As mentioned-above, the figurine 20 is composed of at least one of components 201˜217. Each component is shaped in the same or different pattern. After snapped together, the components can be formed as a dolphin figurine. The components of the present invention is not only used to form a dolphin figurine, but also used to form as a cobra, a hippocampus, a giraffe, kinds of animals, plants, cartoon characters or toy figurine. Because there are a lot of embodiments can be practiced, so the present invention is not restricted to a specific pattern of the figurine 20.

Furthermore, this embodiment is snapped together by 17 components 201˜217 to form a figurine 20. But the components of this embodiment is not only restricted to 17 components as the FIG. 1 illustrated, more than 17 components or less than 17 components are also applicable in this embodiment. However, more components are accommodated to snap together a deformable figurine 20, more alternative steps can be found to shape a new pattern. In other words, at least one component up to twenty, thirty or forty more components being snapped together to form a figurine, numbers of the components should not be restricted to the scope of the claims of the present invention.

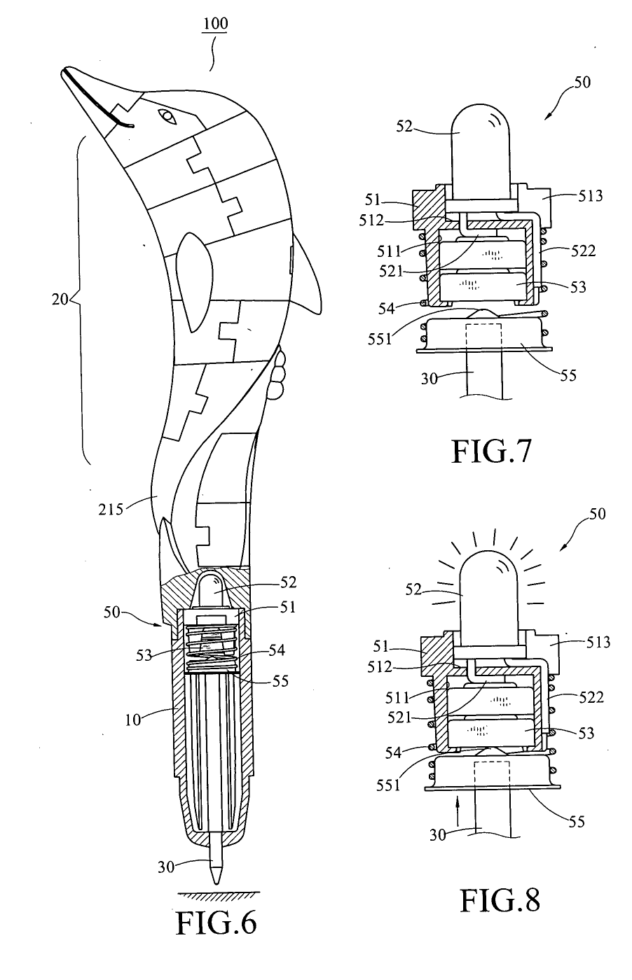

Aforesaid component 215 and the barrel 10 can be formed integrally as a whole by injection molding process. In which the top end of barrel 10 can be formed as a bump pedestal (refer to FIG. 6), which is embedded into a recessed trough formed on the bottom of component 215. As a result, figurine 20 can be coupled to the barrel 10 integrally with the component 215 based on bumps and recesses snapped together effect. Figurine 20 is not only formed by injection molding process, bumps and recesses snapped together process, but also by adhesive, welding, or screwing processes. But the figurine 20 is preferable to be formed by injection molding process and snapped together by bumps and recesses process.

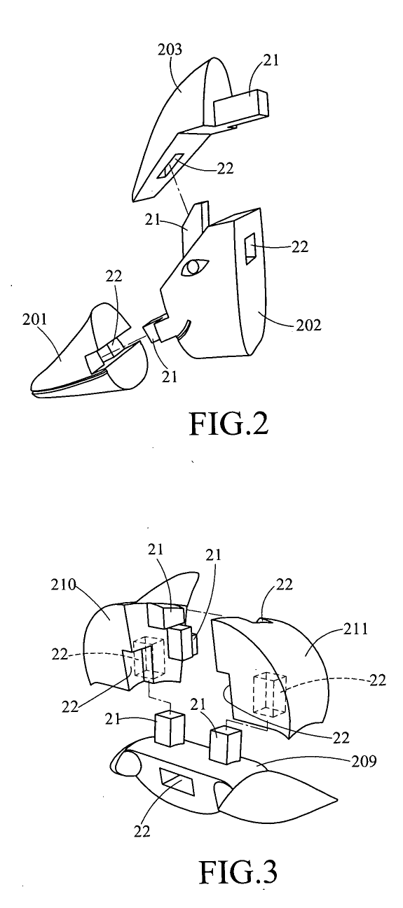

Refer to FIGS. 2 or 3. Partial exploded views of the present invention are illustrated. In which, each of the components 201˜203 has the relative bumps 21 and recesses 22. Joint of bumps 21 and recesses 22 can be snapped together in the orientation of front and rear, right and left, up and down or in oblique symmetry to form as a whole. Such as a head portion of dolphin exemplary embodiment illustrated as shown in FIG. 2, or a waist portion of dolphin exemplary embodiment illustrated as shown in FIG. 3, because each component is shaped in different pattern, in the process of snapped together, users are to consider the orientation of the components and then match them in sequence. Snapping together of figurine is not simply a task completed through one-way thinking, but a challenge of “brain storming”, and then the figurine is coupled to the barrel correctly. It is benefitic for developing the creative, imaginative capacity of the children so that a pen is to be used as a lego type play surface.

As mentioned above, joint of bumps 21 and recesses 22 includes that a male bump matched with a female recess. Such as spherically male bump adapted to a round recess, a pyramid bump coupled with square recess, and cylindrical male bump engaged with round recess.

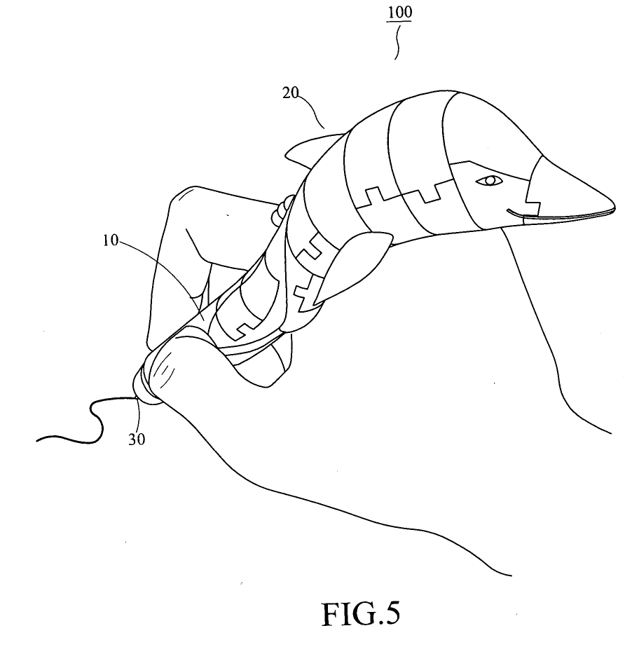

Furthermore, because the lovely patterns of the figurine, it is attractive to the children's attention. The pattern of the figurine 20 is preferred to comply with the principle of ergonomics. Particularly, the components 214˜217, after snapped together, closely conforms to the shape of a portion of the hand between the thumb and the index finger. So the pattern of figurine is designed to adapt to the children's grip portion between the thumb and the index finger. It is helpful for children's writing or drawing. In practice, the embodiment of the present invention is illustrated as shown in FIG. 5.

### Second Embodiment

Refer to FIG. 6. After snapping together, a plan view of the second embodiment of the present invention is illustrated. It is different from the first embodiment, for an emitting light device 50 is added to the top end of the cartridge 30 in the barrel 10. Controlling the emitting light device 50 whether to light up or not is illustrated in many different ways, such as a finger touch triggering switch mounted on the barrel 10 (not shown), a press button triggering switch mounted on the barrel 10 (not shown), or a cartridge 30 received in the barrel 10 in contact with an emitting light device 50. In which, the finger touch or press button switch is generally a small switch manipulated by hand, mounted on the round circumference or multi-sided symmetrical perimeter of the barrel 10. By finger touching, or pressing down the button, the emitting light device 50 is activated to conduct negative current and then light up. It is a conventional technique, so we only discuss the structure and function briefly as above. Since cartridge 30 used to control the emitting light device 50 to light up is a touch control means, the structure is disclosed in U.S. Pat. No. 6,155,700 entitled “Touch control emitting light apparatus” assigned to the applicant Hsu, Ming-Tay on Dec. 5, 2000. It comprises a base 51, an LED 52 mounted in an upper trough 511 of the base 51, the LED 52 has two leads, a short lead is led into a lower trough 512, a long lead 522 is led in the vertical trough 513 then goes across the base 51; two or three batteries 53 mounted in the lower trough 512 of the base 51, the anode of the battery is in contact with a short lead 521 of the LED 52, a compressing spiral spring 54 fits over the circumference of base 51, the upper end of the spring connected to the long lead 522 of the LED 52; a conductive cap 55 is in contact with the lower end of the compressing spiral spring 54 keeps a gap from the batteries 53 in the base 51, the conductive cap 55 resists the cartridge 30.

Refer to FIG. 7. As mentioned above, the short lead 521 of the LED 52 is in contact with the anode of the battery 53, while the cartridge 30 is not applied to write, the cartridge 30 and the conductive cap 55 is urged by the same compressing spiral spring 54 to descend. The dot 551 projected from the center of top surface of the conductive cap 55 is not in contact with the cathode of the battery 53. The negative electricity current is not conducted to the LED 52 so that the LED 52 is not illuminated.

Refer to FIG. 8. The cartridge 30 is pressed to retract back into the barrel 10, the conductive cap 55 ascent, then dot 551 projected at the center of the top surface of the conductive cap 55 is in contact with the cathode of the battery 53. Conducting negative current via the conductive cap 55, and spring 54 to the long lead 522 of the LED 52, the LED 52 is already in contact with a short lead having positive current, now is electrified with the conducted negative current to light up. Conversely, the cartridge 30 is not used to write, conductive cap 55 being resisted by the compressing spiral spring 54, it will be not electrified through the spring, the LED 52 restored to the dim state.

By means of the aforesaid cartridge 30 applied to contact, to control the emitting light device 50 directly, which is activated to light or dim automatically.

What is claimed is:

1. A detachably snap-together pen comprises a hollow, open end barrel 10, a figurine 20 coupled to the barrel, and a cartridge 30 mounted inside the barrel characterized in that:
a figurine 20 is composed of at least one of components, each of the components has relative bumps 21 and recesses 22 respectively, after snapped together, the figurine 20 coupled to the barrel 10.

2. A detachably snap-together pen according to claim 1, wherein through the joint of bumps 21 and recesses 22 the components snapped together in one orientation as following: front and rear, right and left, up and down, or in oblique symmetry.

3. A detachably snap-together pen according to claim 1, wherein a top end of the barrel sealed by a cap 40 for safekeeping a cartridge 30.

4. A detachably snap-together pen according to claim 1, wherein a base component of the figurine 20 is integrally formed with the barrel 10 as a whole by injection molding.

5. A detachably snap-together pen according to claim 1, wherein a base component of figurine 20 coupled to the top end of barrel 10 by bumps and recesses snapped together manner.

6. A detachably snap-together pen according to claim 1, wherein a cartridge 30 put in the open ended barrel 10, an illuminating device 50 secured to the top end of the cartridge 30.

7. A detachably snap-together pen according to claim 6, wherein the illuminating device 50 lights up or not is switched by a finger-touch triggering switch.

8. A detachably snap-together pen according to claim 6, wherein the illuminating device 50 lights up or not is switched by a press-button triggering switch.

9. A detachably snap-together pen according to claim 6, the illuminating device 50 light or dim being controlled by a cartridge 30, the illuminating device 50 comprising:
a base 51;
an LED 52 mounted in an upper trough 511 of the base 51, the LED 52 has two leads, a short lead is led into a lower trough 512, a long lead 522 is led in the vertical trough 513 then goes across the base 51;
two batteries 53 mounted in the lower trough 512 of the base 51, the anode of the battery is in contact with a short lead 521 of the LED 52;
an expandable spring 54 is provided to fit over the circumference of base 51, the spring 54 is in contact with the long lead 522 of the LED 52; and
a conductive cap 55 is in contact with a lower end of the expandable spring 54 keeps a gap from the battery 53 in the base 51, the conductive cap 55 resists the cartridge 30.
